(19) United States
(12) Patent Application Publication
(10) Pub. No.: US 2015/0188701 A1
(43) Pub. Date: Jul. 2, 2015

(54) SCALABLE SOFTWARE ARCHITECTURE FOR QUANTUM CRYPTOGRAPHIC KEY MANAGEMENT

(71) Applicant: Los Alamos National Security, LLC, Los Alamos, NM (US)

(72) Inventors: Jane E. Nordholt, Los Alamos, NM (US); Richard John Hughes, Los Alamos, NM (US); Jane Marie Riese, Los Alamos, NM (US); Christine Marie Ahrens, Los Alamos, NM (US); Charles Glen Peterson, Los Alamos, NM (US); James William Harrington, Moorpark, CA (US)

(21) Appl. No.: 14/423,551

(22) PCT Filed: Aug. 16, 2013
(86) PCT No.: PCT/US13/55356

§ 371 Date: Feb. 24, 2015

Related U.S. Application Data
(60) Provisional application No. 61/693,131, filed on Aug. 24, 2012.

(51) Int. Cl. H04L 9/08; H04L 29/06

(52) U.S. Cl. CPC H04L 9/0852; H04L 63/061; H04L 2209/24

(57) ABSTRACT

A protocol processor for exchange of messages in a quantum cryptographic system includes a common database for message parameter storage. Message exchanges between user stations are based on parameters extracted from messages and stored, and subsequently retrieved and inserted into new messages.

### CROSS REFERENCE TO RELATED APPLICATION

This application claims the benefit of U.S. Provisional Patent Application No. 61/693,131, filed Aug. 24, 2012, the disclosure of which is hereby incorporated by reference.

### ACKNOWLEDGMENT OF GOVERNMENT SUPPORT

This invention was made with government support under Contract No. DE-AC52-06NA25396 awarded by the U.S. Department of Energy. The government has certain rights in the invention.

### FIELD

The disclosure pertains to cryptographic systems.

### SUMMARY

According to some examples, methods comprise receiving a plurality of messages associated with quantum cryptographic communications between two or more user stations, and storing at least portions of the plurality of the messages in a common database. In some examples, the common database is situated at a base station. In other examples, parameters associated with a message from a first user station in the common database are stored, and a message to a second user station is prepared based on the stored parameters from the second user station. In other examples, at least one computer readable medium comprises computer-executable instructions for such methods.

In other examples, protocol processors comprise a computer readable memory configured to store message parameters associated with quantum cryptographic communications between at least a first user station and a second user station. A message parser is configured to extract message parameters from stored received message parameters from the first user station and a message generator is configured to prepare messages for the second user station based on the extracted message parameters. In some examples, the extracted parameters include one or more of an encryption key, a key derivation key, a key authentication key, an authentication key, a key identifier, a sifted bit number in one or more bases, a basis identifier, and an authentication tag. In further examples, a computer readable memory is situated at a base station that is coupled to communication with a plurality of user stations.

### BRIEF DESCRIPTION OF THE DRAWINGS

FIG. 1 illustrates a representative communication system having quantum and public channel.

FIG. 2 illustrates a representative computing environment.

FIG. 3 is a block diagram of a representative method of key distribution.

FIG. 4 illustrates a representative multi-session communication system.

FIG. 5 is a block diagram of a representative protocol processor configured to select functional processing modules from sets of such modules that can be stored in one or more local or distributed databases.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples below, messages and data are described with reference to particular formats such as binary with specific bit lengths. These examples are for convenience description only, and other formats and lengths can be used. Some embodiments refer to communications between ground-based users and satellites, but this is for illustration purposes only. In satellite communications, an orbit identifier and/or an available communication time based on orbital position can be provided, but ground to ground systems are also disclosed. In addition, some examples pertain to quantum key exchange, but the methods and apparatus disclosed herein can also be used in quantum key management, multi-party key distribution between users, and user-to-user key management.

### Representative Multi-Party Quantum Communications Protocol

A representative multi-party quantum communications protocol is described below. Each user i of a set of N users (1≦I≦N) can perform quantum communications (QC) with a trusted authority (TA), but not directly with other users. Each user i performs QC with the TA, creates secure key bits, and divides the secure key bits into the following type keys, wherein n, m, and p are the numbers of keys such as 256-bit keys:

encryption keys (EKs): Kₘ(i)

key derivation keys (KDKs): Lₙ(i)

key authentication key (KAKs): Mₚ(i)

authentication key (AKs): Q(i)

The key authentication keys might be shorter, and in practice the key type might be assigned on the fly but all keys are shown as labeled with an index. Typically there are as many EKs as KDKs as KAKs, so mₘₐₓ=nₘₐₓ=pₘₐₓ but in some circumstances such as where many direct, encrypted interactions with the TA are needed (for example, if user i is using the TA as a secure data repository), more EKs than KDKs may be preferred. Thus, in general mₘₐₓ≠nₘₐₓ, but nₘₐₓ=pₘₐₓ.

When user i intends to send and receive secure messages with user j, the TA sends the information described below to each user so that they have different send and receive keys. Indices m, n, p, q, r, s, t, u, v and w are used to indicate key index numbers which in some cases must be sent to a user as below.

For secure communication between user i, and user j the TA sends the following to user i: 1) pair key P_{q}(i, j)=Lₙ(i)⊕Kᵣ(j), 1≦i, j≦N, i≠j; 2) a value of n to determine which of i's stored KDKs Lₙ(i) to use; 3) an authentication value Aₛ(i, j)=h[Kᵣ(j); Mₚ(i)], wherein h is a cryptographic hash function such as SHA256, 1≦i, j≦N, i≠j; a value of p to use from i's stored KAKs Mₚ(i); and a value t of the EK Kₜ(i) to use to read messages from user j. User i then derives 1) Kᵣ(j)=Lₙ(i)⊕P_{q}(i, j) for use in sending messages to user j; and A_{s′}(i, j)=h[Kᵣ(j); Mₚ(i)] and checks that this is the same as the receive authentication value A_{s′}(i, j)=Aₛ(i, j). If not, Kᵣ(j) is rejected.

The TA sends the following to user j: 1) a pair key Pᵤ(j, i)=Lᵥ(j)⊕Kₜ(i), 1≦i, j≦N, i≠j; 2) a value of v to use from j's stored KDKs Lᵥ(j); 3) an authentication value A_{w}(j, i)=h[Kₜ(i); Mₓ(j)], 1≦i, j≦N, i≠j; a value of x to use from j's stored KAKs Mₓ(j); and 4) a value r of j's EKs Kᵣ(j) to use to read messages from user i. User j then derives: 1) Kₜ(i)=Lᵥ(j)⊕Pᵤ(j, i) for use in sending messages to user i; and 2) A_{w′}(j, i)=h[Kₜ(i); Mₓ(j)] and checks that A_{w′}(j, i)=A_{w}(j, i). If not, Kₜ(i) is rejected.

### Representative Protocol for Secret Bit Generation Between a User and a TA

In the following example, secret bit generation (SBG) is described based on certain convenient assumptions. The transmitter and receiver are assumed to have agreed upon a required confidence level (1-ε), wherein ε is a small user-defined parameter, typically less than 10⁻⁵, for each step of the protocol and share a secret 256-bit random string to use for message authentication. The transmitter is assumed to not leak any basis information on single-photon transmissions at the time of transmission, and the receiver's choice of measurement basis is uncontrolled by any adversary. The transmitter and receiver never leak bit information, and, for an input string with at least 256 bits of entropy, the output of the Secure Hash Algorithm SHA-256 has 256 bits of entropy. In the following, it is implicit that the user is the transmitter and the TA the receiver, but this is in no way limiting, and the roles could be reversed.

### DEFINITIONS

For convenience in describing the representative protocol, the following definitions are used:

clock cycle: interval between laser firings (for example, 100 ns).

run: a duration of a quantum transmission.

mode: transmission patterns. for example, mode 1 (periodic), mode 2 (pseudo-random), mode 3 (pseudo-random with diagnostics), calibration modes, and key generation mode.

session: a set of runs selected from a single contact

Alice: a transmitter pseudonym, typically a user, user station, mobile station, or satellite

Bob: a receiver pseudonym, typically also a trusted authority, base station, or ground station

Uplink: Bob-to-Alice communication

Downlink: Alice-to-Bob communication

### Quantum Communications

In this example, the BB84 protocol is used (see Bennett and Brassard, “Quantum cryptography: Public-key distribution and coin tossing,” Proceedings of IEEE International Conference on Computers, Systems and Signal Processing, pp. 175-179, December 1984, which is incorporated herein by reference) with some added modifications including decoy states and a revised information estimate. The quantum signals comprise highly-attenuated laser pulses (with a mean photon number μ<1) with information encoded into photon polarization. A zero is encoded as either a horizontal) (0° or diagonal) (45°) polarization, and a one is encoded as either vertical) (90° or antidiagonal polarization) (−45°). Z denotes the rectilinear horizontal and vertical polarization basis and X denotes the diagonal and anti-diagonal polarization basis. Decoy states are provided to randomly vary the intensity of the laser pulses in order to better map out the effective quantum channel. On each clock cycle, one of three levels (vacuum (V), low (L), or high (H)) is randomly chosen for the mean photon number of that pulse. The quantum signals can be produced by pulsing a single linearly polarized laser, followed by a polarization modulation stage to produce the desired state. Alternatively, a separate laser can be pulsed for each polarization state and the outputs optically combined. In the following we will describe this second method, but the description is in no way limiting and the generalization to the first method is obvious. When a vacuum level is chosen, no laser fires. When a low or a high level is chosen, a laser prepares one of the polarization states with mean photon number μ_{L}˜0.1 or μ_{H}˜0.5, respectively. The exact intensities and their relative frequencies are specified in advance for each session. Decoy states are described in, for example, Harrington et al., “Enhancing practical security of quantum key distribution with a few decoy states,” LANL Report LA-UR-05-1156 (2005), which is incorporated herein by reference.

### Conventional Communication

In a first uplink, session setup information, including when to start transmitting quantum signals, the duration of transmission, the modes for each run, and decoy state levels can be sent. In a first downlink, after quantum transmission, seeds for bitstreams used to generate bases and intensities can be sent. In a next uplink, sifting information (detections at Bob that were measured in a same basis as the transmitter's preparation) and a choice of codes for error correction can be sent. In a next downlink, syndrome information for error correction along with verification checks can be sent along with seeds for bitstreams used to generate bit values for any pseudo-runs. In final uplink, error correction success can be signaled, and privacy amplification information sent.

### SBG Protocol

### Session Setup

To initiate a contact with Alice, Bob constructs a setup message M1 that includes Tₛₜₐᵣₜ, Nᵣᵤₙₛ, T_{public}, μ_{H}, μ_{L}, p_{V}, p_{L}, and mᵢ, defined as follows. Tₛₜₐᵣₜ is unique session identifier, such as a date/time value indicating a number of seconds since or before a fixed date, Nᵣᵤₙₛ is a number of runs of quantum transmission, T_{public} corresponds to a date and time after which basis information can safely be revealed in public communication, μ_{L} is a mean photon number for the low pulses, μ_{H} is a mean photon number for the high pulses, p_{V} is a probability of choosing vacuum, p_{L} is a probability of choosing low pulse intensity, mᵢ (2 bits) are mode numbers for each run of the session. Various numbers of bits can be used for any of the above, typically 32 bits for most values and 3 bits for probabilities.

Bob then computes H1=HMAC(M1) (see below) and communicates M1 to Alice with authentication tag H1. Alice verifies Bob's authentication tag H1==HMAC(M1).

### Quantum Transmission

For each run, Alice determines which laser will fire for each clock cycle, depending upon the mode. There are 3 diagnostic modes, pattern 1, pattern 2 and pattern 3, which are not used for secret bit generation, and a fourth mode for key generation. For example, for run i, if m, is pattern 1, then Alice fires each laser in a periodic sequence. If m, is pattern 2 or pattern 3, then Alice initializes 128-bit values Aⱼ, Bⱼ, and Cⱼ (for 1≦j≦8) to default values defined by the pattern. If mᵢ is a key generation mode Alice utilizes a physical randomizer to create 2048 random bits to initialize Aⱼ and Bⱼ. Each Cⱼ is constructed by concatenating 32-bit values Tₛₜₐᵣₜ, i, j, and a counter initialized to zero.

Eight independent bitstreams named Oⱼ are generated by the pseudo-random number generator defined in the ANSI X9.31 pseudo random number generator protocol using Aⱼ, Bⱼ, and Cⱼ as inputs. Alternatively, another cryptographically strong deterministic random number generator taking secret input seed values as parameters could be used. For each clock cycle, one bit from each output bitstream Oⱼ is used as follows.
O₁: This determines which basis is prepared. ‘0’ can denote the Z-basis, and ‘1’ the X-basis.
O₂, O₃, O₄: These jointly determine which mean photon number (0, μ_{L}, or μ_{H}) to prepare for a pulse, such that vacuum is chosen with probability p_{V}, and μ_{L} is chosen with probability p_{L}.
O₅: This gives the encoded bit when μ_{L} and Z are chosen.
O₆: This gives the encoded bit when μ_{L} and X are chosen.
O₇: This gives the encoded bit when μ_{H} and Z are chosen.
O₈: This gives the encoded bit when μ_{H} and X are chosen.
   Once Alice is instructed to begin quantum transmission for a session, Nᵣᵤₙₛ consecutive runs are initiated, using the laser firing order defined above for each run. Alice then records the timestamps of her beam monitor detections and Bob measures the incoming photons in either the X-basis or Z-basis, selected at random.

### Establishing Valid Detections

Bob determines a timing window for accepting detection events. Bob considers a measured bit to be valid for a clock cycle if a detection event occurs during a selected timing window and no other detection events occurred during the N_{dead} clock cycles prior to the event, where N_{dead} is set by the detector dead time for the receiver system. If two or more detectors click in the same timing window, then Bob selects a measured bit at random for that clock cycle. If the detectors correspond to different measurement bases, then Bob also selects a basis at random for that clock cycle.

### Sifting (I)

Alice computes upper bounds μ⁺_{L} and μ⁺_{H} and lower bounds μ⁻_{L} and μ⁻_{H} on her low and high mean photon numbers based on her beam monitor data for each run. Alice constructs a sifting message M2 consisting of Tₛₜₐᵣₜ, followed by A₁, A₂, A₃, A₄, A₅, B1, B₂, B₃, B₄, B₅, and B₆ (keys and pads) for each key generation run, and μ^{±}_{L} and μ^{±}_{H} for every run. Alice also computes H2=HMAC(M2). Alice communicates to Bob M2 with authentication tag H2, and Bob verifies Alice's authentication tag H2==HMAC(M2).

### Sifting (II) and Reconciliation (I)

Bob generates the bitstreams O₁, O₂, O₃, O₄, O₅, and O₆ in the same manner as Alice did for every run. Bob also generates O₇ and O₈ for each pattern run. For each key generation run i, Bob constructs two strings zᵢ and xᵢ consisting of his measured bit values whenever Alice sent μ_{H} and they both chose the Z-basis or X-basis, respectively. Bob records the indices of these sifted bits and compresses them by Golomb-Rice encoding. For each pattern run i, Bob constructs similar strings and directly compares them against what Alice sent. Bob calculates the observed high signal bit error rates Δ_{z,i} and Δ_{x,i}. For every run, Bob also constructs sifted bit strings for the μ_{L} signals and directly compares them against what Alice sent. Bob calculates the observed low signal bit error rates δ_{z,i} and δ_{x,i}. From the observed bit error rates, Bob computes expected bit error rates Δ_{z,i} and Δ_{x,i} for zᵢ and xᵢ.

Based upon the number of sifted bits, their expected bit error rates, and available uplink bandwidth, Bob selects which key generation runs will be included in the session for generating secret bits. Let dᵢ=1 if key generation run i is included; otherwise, let dᵢ=0 denote that key generation run i will be discarded. Bob performs decoy state analysis to compute a lower bound y₁ on the single photon transmission efficiency with confidence level (1-3ε) for the set of included key generation runs. If this bound is unacceptable, he may update his selection of which key generation runs to include. For example, if the bound is zero, Bob might choose to either increase the number of key generation runs or discard all the runs. Bob forms a string z by concatenating zᵢ with dᵢ=1. Bob forms a string x by concatenating xᵢ with dᵢ=1. Let n_{z} and n denote the lengths of z and x, respectively. Bob computes the expected bit error rates Δz and Δx for z and x. Bob selects appropriate error-correcting codes with a high level of confidence of handling these bit error rates. Let c_{z} and cₓ denote the block sizes of the error-correcting codes chosen for z and x, respectively. Bob constructs a sifting and reconciliation message M3 consisting of Tₛₜₐᵣₜ, dᵢ, the compressed indices for each included key generation run, and a description of the two error correcting codes. Bob computes H3=HMAC(M3) and communicates M3 to Alice with authentication tag H3. Alice verifies Bob's authentication tag H3 by computing HMAC(M3).

### Sifting (III) and Reconciliation (II)

Alice constructs two strings for zᵢ and xᵢ for each selected key generation run. Alice concatenates these together to form two strings for z and x for the entire session. Alice and Bob generate a pseudo-random bitstream O_{misc} by the X9.31 protocol using H2 as the key, H3 as the pad, and Tₛₜₐᵣₜ followed by all zeroes as the counter string. Using O_{misc}, Alice and Bob first construct a random permutation of z and then a random permutation of x. Then z and x are replaced with their permuted versions.

Alice and Bob divide z into floor[n_{z}/c_{z}] reconciliation groups z (j) of size c_{z} bits. Any leftover bits are discarded. Similarly, Alice and Bob divide x into floor[nₓ/cₓ] reconciliation groups x (j) of size cₓ bits.

Using O_{misc}, Alice and Bob first construct a random binary matrix Vz with cz columns and log₂(1/ε) rows and then a random binary matrix Vx with cx columns and 1 log₂(1/ε) rows. Alice computes syndromes P_{z}Z (j) and PₓX (j), and verification checks V_{z}Z₍ⱼ₎ and VₓX₍ⱼ₎x for each reconciliation group. Alice constructs a reconciliation message M4 consisting of Tₛₜₐᵣₜ, the syndromes, and the verification checks. Alice computes H4=HMAC(M4) and communicates M4 to Bob with authentication tag H4. Bob verifies Alice's authentication tag by computing H4==HMAC(M4).

### Reconciliation (III)

Bob performs iterative decoding of the syndromes to reconcile his strings to Alice's strings. If iterative decoding fails to converge after a predetermined number of iterations, then reconciliation of that group fails. Bob compares the verification checks against any successful decoding. If one or more of the verification checks disagree, then reconciliation of that group fails. Bob constructs strings z and x by concatenating together the successfully reconciled strings. Let n_{z} and nₓ denote the number of bits in x and z, r_{z} and rₓ denote the total number of parity bits revealed for x and z, v_{z} and vₓ denote the total number of verification checks revealed for x and z.

### Information Estimate

Using lower bound y₁ on the single photon transmission efficiency, Bob computes lower bounds s_{z} and sₓ on the number of single-photon signals present in x and z. Bob also calculates upper bounds b_{z} and bₓ for the single-photon bit error rates in x and z. Let f_{z} and fₓ be the fraction of ones in z and x, respectively. Let H₂(p)=p log₂ p−(1−p)log₂(1−p) be the Shannon entropy function and let T(s, b) denote the number of typical strings needed to describe with probability (1-ε) the output of s zeroes transmitted over a binary symmetric channel with bit flip probability b. Let mz=max(0, s_{z}−r_{z}−v_{z}−log₂ T(s_{z}, bₓ)−n_{z}(1−H₂(f_{z}))) and

mx=max(0, sₓ−rₓ−vₓ−log₂ T(sₓ, b_{z})−nₓ(1−H₂(fₓ))). Bob calculates l_{z} and lₓ by the following routine (with appropriate subscripts):

$$i . Let k = ⌊ \frac{n}{256} ⌋ . \\ ii . Let l = ⌊ \frac{n}{k} ⌋$$

$$iii . Let {a}_{0} = {\prod }_{i = 0}^{l - 1} ( \frac{N - n - i}{n - i} ) . \\ iv . Let {a}_{j} = {a}_{j - 1} ( \frac{m - j + 1}{l} ) ( \frac{i - j - 1}{n - m - i - j} ) for j = 1 , 2 , … , 255.$$

$$v . If {\sum }_{j = 0}^{255} {a}_{j} \leq ɛ , then terminate , else increment k by one and go to step ii .$$

### Privacy Amplification

Bob constructs a privacy amplification message M5 consisting of Tₛₜₐᵣₜ, l_{z}, lₓ, and a string of bits denoting success (‘1’) or failure (‘0’) of error correction for each reconciliation group. Bob computes H5=HMAC(M5). Bob communicates to Alice M5 with authentication tag H5. Alice verifies Bob's authentication tag H5==HMAC(M5). Alice constructs strings z and x by concatenating together the successfully reconciled z_{(g)} and x_{(y)}, respectively. Alice and Bob divide z into l_{z} blocks of floor(n_{z}/l_{z}) bits each. Any leftover bits can be included in the last block. Similarly, x is divided into 1ₓ blocks of floor(nₓ/lₓ). A Toeplitz matrix of size 256 by nz/lz is multiplied with z and a Toeplitz matrix of size 256 by nₓ/lₓ is multiplied with x.

### Message Authentication (HMAC)

All data for carrying out the SBG protocol can be authenticated by computing a keyed hashed function of each message exchanged between Alice and Bob. This serves the purpose of both checking the integrity of the messages as well as verifying the identity of the message originator. Specifically, the HMAC standard based on SHA-256 can be used for the hash function, and truncating the output as convenient. This approach requires Alice and Bob to share a small secret string of bits prior to a session. It is important that this key remains secret until all messages authenticated by that key have been processed. An adversary's future knowledge of the key will not leak any information of the secret bits generated by the SBG protocol. A small number of secret bits generated from one session could in principle replace the secret authentication string to be used for the next session.

### Representative System Implementation

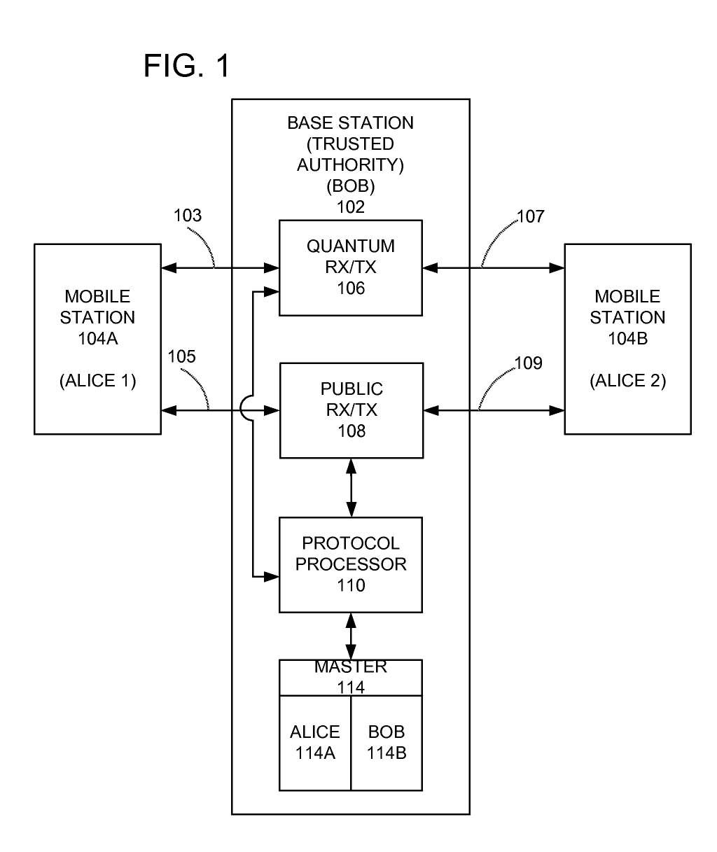

The above communication protocol can be implemented in various configurations. In an example, illustrated in FIG. 1, a base station 102 (the TA) is configured to store data and receive quantum detections with one or more mobile or remote station users 104A, 104B. In some examples, the base station is a ground station configured to communicate with a satellite or other mobile transmitter, and can control communication with the transmitter such as planning for access to the transmitter. In other examples it could be a network server connected to users by optical fiber. In yet other examples it could be a server to which user's mobile/handheld devices connect while docked for recharging. Typically, both base stations and mobile stations are configured to both transmitters and receivers for one or both of conventional and quantum communications. The base station 102 can be configured to control operation of various operational modes as discussed above.

For purposes of illustration a trusted authority is shown as a base station and referred to as “Bob” and user or mobile devices are referred to as “Alice.” In typical communications, the protocol processor 110 is configured to determine if Bob or Alice is responsible for processing, and based on such a determination, instantiate a suitable processing class.

The base station 102 includes a quantum data receiver/transmitter (quantum transceiver) 106 that is configured for quantum data communications over a quantum data channels 103, 107 and a public channel receiver/transmitter 108 (public transceiver) configured to communicate over conventional data channels 105,109 such as optical or electrical data channels. The base station 102 also includes a protocol processor 110 that is implemented using a series of computer-executable instructions that are stored in a computer readable medium for execution on a dedicated or general purpose processor. Alternatively, the protocol processor 110 can be implemented in a field-programmable gate array or other device as may be convenient. The base station also includes a so-called “master” database 114 that is configured to store encryption keys, key derivation keys, key authentication keys, authentication keys, and other parameters as necessary. As shown in FIG. 1, the master database includes databases 114A, 114B that are assigned for data storage and retrieval for the mobile stations 104A, 104B, respectively. Typically, the protocol processor 110 is configured to retrieve data from one of the databases 114A, 114B and store the retrieved data in the other of the databases 114A, 114B.

### Protocol Processor

The protocol processor 110 can be implemented based on Base Station and Mobile Station classes that are configured so that the classes do not share information except via messages sent between them. Separate computing devices could be used with messaging connection (such as TCP-based communication). The protocol processor 110 typically writes (stores) messages (as binary or other message formats) to a common file directory at the database 114. Both base stations and mobile stations can access the database 110 to retrieve appropriate messages.

The protocol processor 110 is re-entrant so that in any communication process, single messages can be communicated. The database 114 provides a time. The database is the permanent memory storage for the next process to retrieve the state of the program. The program can also run in a single session (or process) which simulates a continuous communication between Bob (TA/base station) and mobile device Alice for the entire back-and-forth strategy of the SBG protocol. In typical communications, the protocol processor 110 is configured to determine if TA/base station Bob or user/mobile station Alice is responsible for processing, and based on such a determination, instantiates a suitable processing class.

### Protocol Messages

### Message M1

An initial message (M1) provides a unique session identifier. For example, a communication session such as an orbit, a conversation, or other particular communication interval can be identified. Other parameters that can be provided in M1 include a User ID, message ID, a time (a current or desired transmit time) for a user to receive messaging, an acceptance (OK/not OK), a transmission time, a channel for receiver responses, a start time Tₛₜₐᵣₜ, a number of runs to be performed Nᵣᵤₙₛ, the time at which sifting can begin T_{public}, and for each run, i, mean photon numbers to be used, μ_{H}, μ_{L}, decoy state probabilities, p_{V}, p_{L}, and the mode, mᵢ.

M1 values are created and stored in a database table as controlled by the protocol processor 110. Some or all M1 content can be sent to Alice. TA/base station Bob obtains M1 information from the database keyed on a session identifier. The M1 message can be packed by creating a binary file using a selected number of bits for each value. The message is authenticated using the HMAC algorithm on the message contents and an authentication tag H1 is added to the end of M1. The message M1 concatenated with H1 message is ‘uplinked’ by storage in a common directory used by user/mobile station Alice and TA/base station Bob, such as the database 114. The messaging described in this example can be between a satellite (Alice) and a ground station (Bob) or between any other destinations.

### Message M2

After quantum transmission is completed, a message M2 is sent indicating that transmission is finished. The following table lists representative parameters, all of which are generally already known to Bob, so that some parameters can be omitted if desired. Keys and pads can be included as well, but are not shown in the table.

| | |
|---|---|
| MessageID | 2 |
| Size | Number message bytes (including header, H2) |
| Session ID | Unique identifying number. |
| H2 | Authentication tag |

Alice ‘receives’ the M1 Message by reading the M1 binary file in the common directory and populating an M1 message. Alice creates an M2 Message using some of the data in the M1 message. The M2 message is authenticated using HMAC, and an H2 tag is appended. This message is ‘downlinked’ by writing it to the common directory used by Alice and Bob.

### Message M3

A message M3 is sent based on valid detection information by sending the compressed indices of all the valid detections. Representative message fields are shown in the table below.

| | |
|---|---|
| MessageID | 3 |
| Size | Number of bytes in message |
| Session ID | Unique identifier. |
| DetectDataSetID | Data set ID. |
| RunID | First run with valid detections. |
| CompressParamZ | Golomb-Rice compression parameter |
| ZiSize | Number of bits in Zi |
| Zi | Compressed indices Z. |
| CompressParamX | Golomb-Rice compression parameter |
| XiSize | Number of bits in Xi |
| Xi | Compressed indices X |
| RunID | The last run in this message. |
| H3 | Authentication tag |

Bob ‘receives’ an M2 Message by reading a binary file in the common directory. Bob then initiates reading of a timestamp file, determines valid detections, and creates another file ‘detections’ which is written to the common directory. A histogram of all the detectors combined can be obtained. Timestamps can be sorted by detector first and then histogrammed separately. Valid detections are determined by first converting timestamps to relative time and keeping track of the corresponding channel number for that timestamp. The relative times of the timestamps are ‘binned’ into one of 2000 bins and relative high and low values are determined. A detection is valid if it falls between the relative high and low values. The valid detections file can be written to the common directory in the format: RunID:correctedTime*inverseClockRate:basis:bit. Indices of all valid detections can be stored in a Bob_Sifted table. Later this table can be cleared and only the sifted indices stored here. Bob then creates an M3 message consisting of the compressed indices Z and X of the valid detections for each run, the Golomb Rice compression parameters, and the number of bits of compressed data for Z and X for each run. The M3 message is then authenticated using HMAC and an H3 value appended. The M3 message is stored in the common directory.

### Message M4 (Downlink)

A message M4 includes sifting information (the basis) for each of the valid detection indices sent in message M3. Representative message fields are listed in the table below.

| | |
|---|---|
| MessageID | 4 |
| Size | Number of bytes in message. |
| SessionID | Unique identifying number. |
| DetectDataSetID | The ID of the data set used in this protocol session |
| | from the ‘establish valid detections’ process. |
| NumRuns | The number of runs sent in M3. |
| NumZBasisBits | The number of sifted Z basis bits |
| NumXBasisBit | The number of sifted X basis bits |
| ZBasisBits | Alice's Z basis values for the valid detection indices. |
| XBasisBits | Alice's X basis values for the valid detection indices |
| H4 | Authentication tag |

Alice ‘receives’ the M3 Message by reading in the binary file from the common directory and populating an M3 message object with the values in the file. A random basis file is retrieved, and a random basis array is populated. The Z and X indices of each of the runs in the M3 Message is decompressed using the Golomb Rice algorithm and the corresponding basis is obtained from the basis array created from the random basis file. These basis bits are concatenated into Z and X strings (vectors of Booleans). The M4 Message is constructed with the Z and X basis values for the valid detections. The message is authenticated using HMAC and the H4 tag is appended and ‘downlinked’ by writing it to the common directory.

### Message M5 (Uplink)

An M5 message includes sifting information (detections at Bob that were measured in the same basis as the transmitter's preparation) and the choice of codes for error correction.

| | |
|---|---|
| MessageID | 5 |
| Size | Number of bytes in message. |
| SessionID | Unique identifying number. |
| DetectDataSetID | The ID of the data set used in this protocol |
| | session from the ‘establish valid detections’ |
| | process. |
| RunGroupID | The id of the run group. |
| NumKeyGenRuns | Number of key generation runs. |
| RunID | First run in this run group. |
| CompressParamZ | Golomb-Rice compression parameter. |
| ZiSize | Number of bits in Zi. |
| Zi | Compressed indices Z. |
| CompressParamX | Golomb-Rice compression parameter. |
| XiSize | Number of bits in Xi. |
| Xi | Compressed indices X. |
| ErrCCZID | Error correcting code ID for Z values. |
| | Number of parity bits for default block size. |
| ErrCCXID | Error correcting code ID for X values. |
| | Number of parity bits for default block size. |
| NumVerificationChecks | Number of verification checks per reconcilia- |
| | tion group. Ceiling[log₂(1/ε)] |
| H5 | Authentication tag |

The runs are sifted. Alice's basis values have been sent in the M4 Message for all the valid detections. Bob reads the detections file and determines if the same basis has been chosen. The sifted indices Z and X are compressed using Golomb Rice compression and stored for each run in the database along with the sifted bits. The random basis and bits were selected during earlier processing and have been recorded in the ‘detections’ file that is read by Bob as he sifts. For each run Bob gathers statistics: the number of sifted bits Z and X, the fraction of l's Z and X, and the number of detection counts. After processing all the runs, Bob selects a run group that includes runs that have sifted bits for both Z and X basis. If the Run Group is satisfactory, Bob continues handling of the M4 message and creation of an M5 message. An error correction code such as Gallager Low Density Parity Check (LDPC) Error Correction is applied. Bob also retrieves a ‘confidence level’ from the common database. Alternatively, a confidence level can be preassigned. Then, a number of verification checks is computed as: Num_verif_checks=(int)(ceil(log(confidence_level)/log(0.5).

Bob then creates the M5 message consisting of the compressed sifted indices, the compression parameter used by Golomb Rice compression, and the number of bits of compressed data for Z and X for each run in the Run Group. Finally, the error correction IDs Z and X and the number of verification checks for the entire future Reconciliation Group is appended to the message. The M5 message is then authenticated using HMAC and the H5 value appended. The M5 message is ‘uplinked’ to the common directory.

### Message M6 (Downlink)

A message M6 can include syndrome information for error correction along with verification checks. For convenience, syndromes and verification fields can be padded to a full byte. The Protocol Processor will know from previous computation what the actual length of the field was. The message will first list the syndrome and the verification checks for all the Z reconciliation groups and then send the syndrome and verification checks for the X reconciliation groups.

| | |
|---|---|
| MessageID | 6 |
| Size | Number of bytes in message including header and |
| | authorization tag. |
| SessionID | Unique identifying number. |
| DetectDataSetID | The ID of the data set used in this protocol session |
| | from the ‘establish valid detections’ process. |
| RunGroupID | The id of the run group used in this session. |
| NumZRecGroups | The number of Z reconciliation groups sent in this |
| | message. |
| NumXRecGroups | The number of X reconciliation groups sent in this |
| | message. |
| RecGroupType | Either Z or X. Message starts with Z reconciliation |
| | groups. |
| RecGroupID | Both Z and X RecGroupIDs start at 1 so there will be |
| | RecGroupType Z with RecGroupID 1 AND |
| | RecGroupType X with RecGroupID 1, etc. |
| SyndromeSize | Size of Syndrome message field in bits |
| Syndrome | Syndromes for this reconciliation group. This field is |
| | padded with 0's to a full byte length. |
| VerificationSize | Size of verification message field in bits. |
| Verification | Verifications for this reconciliation group. |
| RecGroupType | Either Z or X. Message ends with X reconciliation |
| | group types. |
| RecGroupID | Both Z and X RecGroupIDs start at 1 so there will be |
| | RecGroupType Z with RecGroupID 1, RecGroupType |
| | X with RecGroupID 1, etc. |
| SyndromeSize | Size of Syndrome message field in bits |
| Syndrome | Syndromes for this reconciliation group. |
| VerificationSize | Size of verification message field in bits. |
| Verification | Verifications for this reconciliation group. |
| H6 | Authentication tag |

Alice ‘receives’ the M5 Message by reading in the binary file from the common directory and populating an M5 message object with the values in the file. She then reads in her random bit and basis file and populates a random bit array with the values. Alice then decompresses each of the runs in the M5 Message using the Golomb Rice algorithm and then gets the corresponding sifted bit from the bit array for each of the sifted indices in the M5 Message for both the Z and X basis. These sifted bits are concatenated into Z and X strings (vectors of Booleans) for all the runs in the Run Group.

The long sifted Z and X strings are then permuted using the Knuth algorithm and the X9.31 random number generator that has been seeded with the H4 and H5 authentication tags. The Knuth algorithm is described in D. E. Knuth, The Art of Computer Programming Vol. II—Seminumerical Algorithms, 2^{nd} ed. pg. 139 (1981). (Bob will use the same initialization of his RNG so that both sides permute identically).

The permuted strings are divided into Z and X Reconciliation Groups of a selected size. Using the error correction code ID in the M5 message, an error correction child graph with the correct number of parity checks is made for both the Z and X basis. These child graphs are written to the common directory. For all the Reconciliation Groups Z and X the Syndrome is calculated using the LDPC code. Using the number of verification checks sent in M5, a verification check is run on the sifted bits in each Reconciliation Group Z and X and returns the parity checks used to verify the bits. All the Reconciliation Groups and their sifted bits, syndromes, and parity bits are stored to the database.

The M6 Message is constructed consisting of all the information in the Reconciliation Groups. The message is authenticated using HMAC and the H6 tag is appended to it. It is then ‘downlinked’ by writing it to the common directory.

### Message M7 (Uplink)

Success of error correction and privacy amplification information is sent in a message M7. This message indicates which reconciliation groups successfully passed both syndrome and verification checks. Each bit in RecResultZ and RecResultX binary fields corresponds to a single reconciliation group and that bit will be set to 1 if the reconciliation group passed both the syndrome and verification check; otherwise it will be set to 0. The number of privacy amplification blocks is included at the end of the message.

| | |
|---|---|
| MessageID | 7 |
| Size | Number of bytes in message. |
| SessionID | Unique identifying number. |
| DetectDataSetID | The ID of the data set used in this protocol |
| | session from the ‘establish valid detections’ |
| | process. |
| RunGroupID | The id of the run group used in this session. |
| RecResultSizeZ | Size of RecResultZ in bits |
| RecResultZ | String of bits denoting success(1) or failure (0) |
| | of error correction for each Z reconciliation |
| | group. |
| RecResultSizeX | Size of RecResultX in bits |
| RecResultX | String of bits denoting success(1) or failure (0) |
| | of error correction for each X reconciliation |
| | group. |
| NumPrivAmpBlocksZ | Number of privacy amplification Z blocks |
| NumPrivAmpBlocksX | Number of privacy amplification X blocks |
| NumBitsForPrivAmpZ | Number of bits used for Toeplitz Z |
| NumBitsForPrivAmpX | Number of bits used for Toeplitz X |
| H7 | Authentication tag |

Bob ‘receives’ the M6 Message by reading in the binary file from the common directory and populating an M6 message object with the values in the file. Bob then retrieves the Run Group from the database and then the sifted bits for this Run Group from the database and concatenates these sifted bits into two Boolean vectors X and Z. Because of how these bits are stored and padded in the database there is some re-arranging to get the bits into the two vectors.

After the sifted bits are retrieved from the database into the X and Z Boolean vectors, each of these is permuted using Knuth's algorithm and the X9.31 RNG which has been initialized with the authentication tags H4 and H5. The permuted vectors are divided into Reconciliation Groups of a selected size. The error correction codes Z and X and the number of verification checks are retrieved from the database. Using the syndromes and verification checks sent in the M6 message, Bob computes the errors of each of the Reconciliation Groups and performs the verification checks and creates a long string of verified bits for both Z and X. Bob then calculates various statistics using an InfoEstimate class such as those pertaining to bit errors, parity checks, entropy, fractions of on bits in reconciled bit strings, and confidence levels. Privacy amplification using a Toeplitz Matrix or another suitable hash function is then performed on the Z and X verified bits resulting in the secret bit strings SBGZ and SBGX on Bob's side. The results are stored to the database and the M7 message is constructed which reveals the results of the error correction and the size of the privacy amplification blocks and the size of the Toeplitz Matrix. The M7 message is ‘packed’, authenticated and written to the common directory.

### Message M8 (Downlink)

Message M8 described below can be used for validation and testing. Message M8 is generally not used in operation, because message M8 permits unauthorized recovery of secret bits. A message M8 contains keys and pads and the secret bits which are to be are sent for validation.

| | |
|---|---|
| MessageID | 8 |
| Size | Number of bytes in message including header and |
| | authorization tag. |
| SessionID | Unique identifying number. |
| DetectDataSetID | The ID of the data set used in this protocol session |
| | from the ‘establish valid detections’ process. |
| RunGroupID | The id of the run group used in this session |
| NumKeyGenRuns | Number of selected key generation runs in this session |
| | and sent in this message. |
| SBGSizeZ | Size of SBGZ in bytes |
| SBGZ | Secret bits Z |
| SBGSizeX | Size of SBGX in bytes |
| SBGX | Secret bits X |
| H8 | Authentication tag |

Alice ‘receives’ the M7 Message by reading in the binary file from the common directory and populating a M7 message object. Alice retrieves H4 and H5 authentication tags from the database and initializes an X9.31 RNG with these values. Alice then retrieves the verified bits from the Reconciliation Groups in the database and constructs the Z and X vectors of verified bits by concatenating the bits of the Reconciliation Groups that passed error correction as indicated in the M7 message. Alice then performs Privacy Amplification using the size of the Toeplitz Matrix sent in the M7 message and the same seeds for the X9.31 RNG used by Bob. Upon completion of the Privacy Amplification step, Alice will have the same secret bit strings SBGZ and SBGX as Bob. Alice stores these in the database and writes them to the common directory.

### Verification and Summary

A verification and summary step can be included. Bob ‘receives’ the M8 Message by reading in the binary file from the common directory and populating a M8 message object. Bob retrieves his SBGZ and SBGX from the database and compares them with the SBGs in the M8 message. If they are identical, Bob declares a successful completion of the SBG protocol and writes out a summary of the session in the common directory.

In other examples, M1-M3 can be configured for multi-party transmission. This could be done simply with separate IDs and then later enhanced with authentication. Histograms can be constructed for each of the detectors and the high and low values of each used to determine valid detections. A flag can be added to indicate whether long or short timestamp formats are to be used.

### Representative Computing Environment

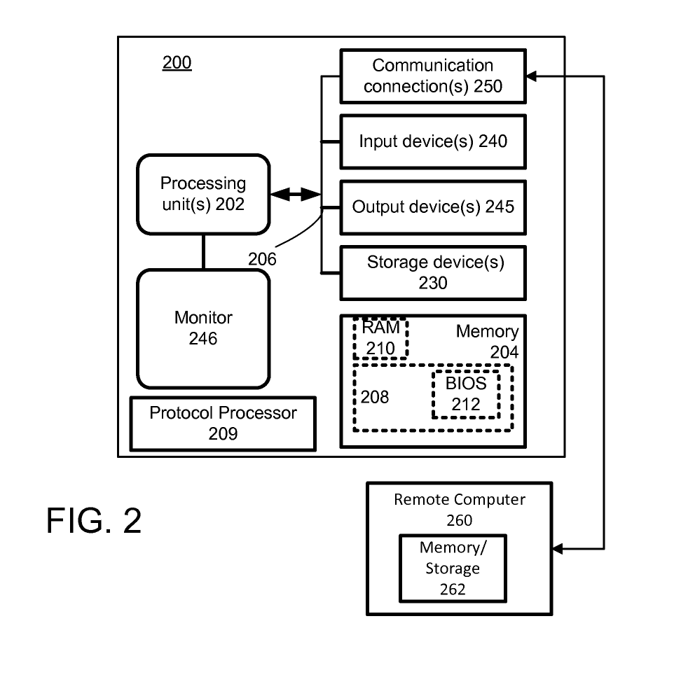

FIG. 2 and the following discussion are intended to provide a brief, general description of an exemplary computing environment in which the disclosed technology may be implemented. Although not required, the disclosed technology is described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 2, an exemplary system for implementing the disclosed technology includes a general purpose computing device in the form of an exemplary conventional PC 200, including one or more processing units 202, a system memory 204, and a system bus 206 that couples various system components including the system memory 204 to the one or more processing units 202. The system bus 206 may be any of several types of bus structures including a memory bus or memory controller, a peripheral bus, and a local bus using any of a variety of bus architectures. The exemplary system memory 204 includes read only memory (ROM) 208 and random access memory (RAM) 210. A basic input/output system (BIOS) 212, containing the basic routines that help with the transfer of information between elements within the PC 200, is stored in ROM 208. A protocol processor 209 can also be included as computer-executable instructions for a general purpose or dedicated processor, or in a field programmable gate array. Instructions for the communication methods described herein can be stored in ROM, RAM, or combinations thereof, on in other computer-readable devices and media. Protocol processing instructions can be provided at a central or remote server, distrusted in a WAN, or provided at a client device as may be convenient.

The exemplary PC 200 further includes one or more storage devices 230 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 206 by a hard disk drive interface, a magnetic disk drive interface, and an optical drive interface, respectively. The drives and their associated computer-readable media provide nonvolatile storage of computer-readable instructions, data structures, program modules, and other data for the PC 200. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 230 including an operating system, one or more application programs, other program modules, and program data. A user may enter commands and information into the PC 200 through one or more input devices 240 such as a keyboard and a pointing device such as a mouse. Other input devices may include a digital camera, microphone, joystick, game pad, satellite dish, scanner, or the like. These and other input devices are often connected to the one or more processing units 202 through a serial port interface that is coupled to the system bus 206, but may be connected by other interfaces such as a parallel port, game port, or universal serial bus (USB). A monitor 246 or other type of display device is also connected to the system bus 206 via an interface, such as a video adapter. Other peripheral output devices, such as speakers and printers (not shown), may be included.

The PC 200 may operate in a networked environment using logical connections to one or more remote computers, such as a remote computer 260. In some examples, one or more network or communication connections 250 are included. The remote computer 260 may be another PC, a server, a router, a network PC, or a peer device or other common network node, and typically includes many or all of the elements described above relative to the PC 200, although only a memory storage device 262 has been illustrated in FIG. 2. The personal computer 200 and/or the remote computer 260 can be connected to a logical a local area network (LAN) and a wide area network (WAN). Such networking environments are commonplace in offices, enterprise-wide computer networks, intranets, and the Internet.

When used in a LAN networking environment, the PC 200 is connected to the LAN through a network interface. When used in a WAN networking environment, the PC 200 typically includes a modem or other means for establishing communications over the WAN, such as the Internet. In a networked environment, program modules depicted relative to the personal computer 200, or portions thereof, may be stored in the remote memory storage device or other locations on the LAN or WAN. The network connections shown are exemplary, and other means of establishing a communications link between the computers may be used.

### Representative Client to Base Station Quantum Communications Method

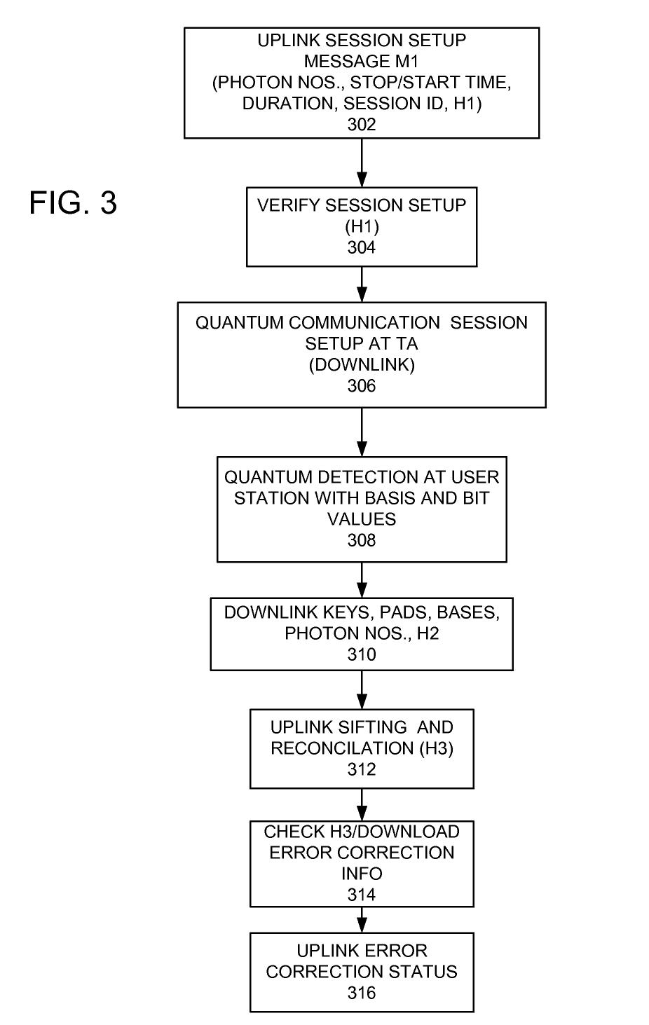

As shown in FIG. 3, a representative method includes initiating session start at 302, typically by specifying one or more of a communication time interval, time duration, photon numbers for decoy states, and session ID. This setup information can be used to establish a hash value H1 that can be used for message authentication. At 304, session startup is acknowledged if the hash value H1 can be confirmed, and at 306, the trusted authority initiates quantum communication. At 308, a user detects transmitted bits along with basis values used to establish bit values. At 310, key, pad, basis and photon number information can be provided to the user at 310, and at 312, sifting and reconciliation information is forwarded to the trusted authority along with a hash value H3 for message authentication. At 314, upon confirmation of the hash value H3, error correction information is delivered to the user and at 316, a status of error correction is uploaded to the trusted authority.

Messages between a user and a trusted authority generally include a message identification field that is associated with content expected in the message (such as for messages M1-M7 described above). In addition, the messages typically include a session identifier. Based on a message identifier and a session identifier, a user (or trusted authority) can track the status of multiple sessions for communications with multiple users. If a particular message is dropped, communication can begin at the most recent successfully delivered message, and either the trusted authority or the user can identify message status, and retransmit or request retransmission.

### Representative Multi-Client Quantum Communication and Quantum Key Management Method

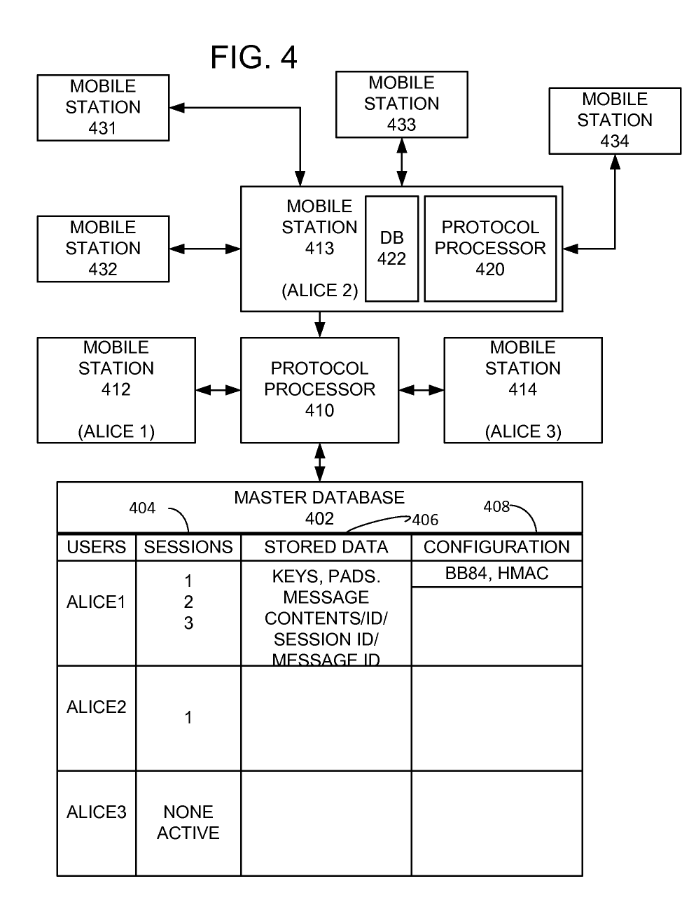

With reference to FIG. 4, a representative key exchange system includes a protocol processor 410 that is situated to communicate with a plurality of user mobile stations 412-414. A master database 402 is in communication with the protocol processor, and is configured to store session information for a plurality of users such as representative users Alice1-Alice 3. The master database 402 can be situated at the protocol processor 410 or in a remote location or locations. As shown in FIG. 4, the master database 402 is configured to store user identifications at 403, session identifiers at 404, stored message data at 406, and communication configurations at 408. User Alice1 is shown as having 3 active sessions, Alice2 has one active session, and Alice3 no active sessions. Message contents (for example, from messages M1-M6 for each of the sessions can be stored, and can be retrieved later as needed in order to confirm message parameters or to permit key recovery for a lost key for one or more sessions. Each session can have a different configuration of quantum protocols, privacy amplification, and hash methods, and FIG. 4 shows BB84 (quantum protocol) and HMAC (hash) as being associated with Alice1's session 1. FIG. 4 also shows that user mobile station 413 can include a protocol processor 420 and an associated master database configured to communicate with user mobile stations 431-434, and thus serve as a trusted authority for key management.

### Modular Protocol Processing

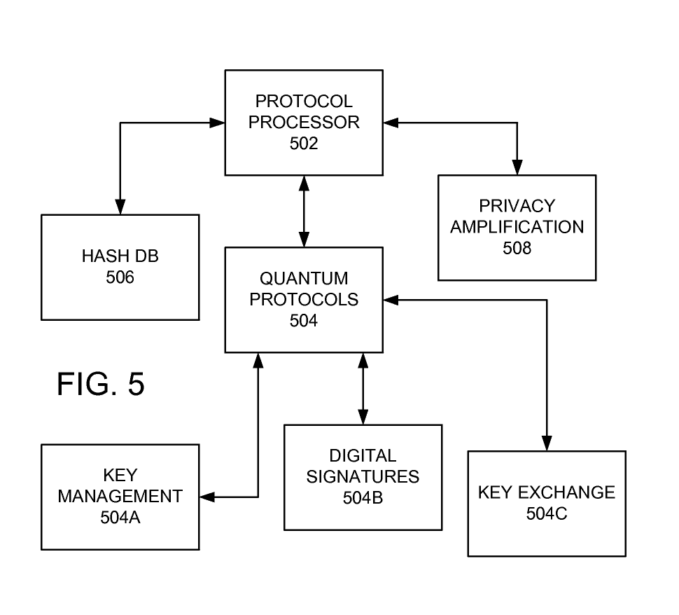

With reference to FIG. 5, a protocol processor 502 is coupled to obtain suitable instructions for customization of key exchange sessions. For example, a quantum protocol can be selected from a set of such protocols stored at 504. Examples include key management protocols 504A, digital signature protocols 504B, and key exchange protocols 504C. Similarly, hashes and privacy amplification methods can be selected from those stored at 506, 508, respectively. The protocol processor is configured to communication in a variety of ways, and multiple active sessions can have different combinations. Additional choices can be readily provided, as desired.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, comprising:
receiving a plurality of messages associated with quantum cryptographic key exchange;
for at least one of the plurality of received messages, storing a message identifier associated with the message; and
based on the stored identifier, transmitting or requesting retransmission of a subsequent message.

2. The method of claim 1, further comprising storing a session identifier associated with a least one user stations

3. The method of claim 1, further comprising identifying at least one key based on retrieved portions of at least one stored message associated with a selected session identifier.

4. The method of claim 1, further comprising reconstructing at least one key based on retrieved portions of at least one stored message associated with a selected session identifier.

5. The method of claim 1, further comprising storing a plurality of session identifiers associated with at least one of the plurality of user stations.

6. The method of claim 1, further comprising storing at least portions of the messages from a plurality of users including the message identifiers in a common database.

7. The method of claim 1, further comprising preparing at least one key exchange message to a user based on stored portions of the plurality of received messages.

8. The method of claim 1, further comprising preparing at least one key exchange messages to a user based only on information in an incoming key exchange message from a user.

9. The method of claim 1, further comprising evaluating stored quantum key distribution information to determine communication statistics, and adjusting at least one communication parameter based on the communication statistics.

10. At least one computer readable medium comprising computer-executable instructions for the method of any one of claims 1-9.

11. A protocol processor, comprising:
a computer readable memory configured to store message parameters associated with quantum cryptographic key exchange; and
a message processor configured to prepare a session setup message that includes at least one mean photon number for quantum cryptographic key exchange and a probability of selecting the at least one mean photon number.

12. The protocol processor of claim 11, wherein the message processor is configured to receive a sifting message associated with bases selected for decoy state quantum communication.

13. The protocol processor of claim 11, wherein the message processor is configured to include an authentication parameter, a session identifier, and a message identifier in the session setup message.

14. The protocol processor of claim 11, wherein the message processor is configured to select at least one of a quantum cryptographic key exchange protocol and at least one message authentication method, and prepare at least one message based on the selected quantum cryptographic key exchange protocol and authentication method.

15. The protocol processor of claim 14, wherein the authentication method is based on a hash function.

16. The protocol processor of claim 11, wherein the message processor is configured to obtain message parameters from stored received message parameters associated with a first user station and a prepare messages based on the extracted message parameters.

17. The protocol processor of claim 16, wherein the extracted parameters include one or more of an encryption key, a key derivation key, a key authentication key, an authentication key, a key identifier, a sifted bit number in one or more bases, a basis identifier, and an authentication tag.

18. The protocol processor of claim 11, wherein the computer readable memory is situated at a base station that is coupled to communication with a plurality of user stations.

19. A scalable software method for managing multiple quantum communications sessions with multiple users, the method comprising:
executing quantum key exchange for the multiple users based on messaging between the multiple users and at least one network node serving as a trusted authority.

20. The method of claim 19, receiving communications from at least some of the multiple users, and directing selected communications to other users of the multiple users based on a session identifier associated with the communication.

21. The method of claim 19, further comprising selecting at least one of a plurality of error correction procedures, quantum key exchange protocols, and privacy amplification and/or authentication function for communication between a selected user and the network node serving as the trusted authority.
